(19) United States
(12) Patent Application Publication
(10) Pub. No.: US 2025/0339980 A1
(43) Pub. Date: Nov. 6, 2025

(54) OPERATION PREVENTION DEVICE FOR A CUTTING TOOL

(71) Applicant: Apex Brands, Inc., Apex, NC (US)

(72) Inventor: Jonathan TUBER, Apex, NC (US)

(21) Appl. No.: 19/197,170

(22) Filed: May 2, 2025

Related U.S. Application Data
(60) Provisional application No. 63/641,610, filed on May 2, 2024.

(51) Int. Cl. B26B 13/28; B23D 29/02

(52) U.S. Cl. CPC B26B 13/28; B23D 29/023

(57) ABSTRACT

An operation prevention device may include an outer shell having a first half shell member and a second half shell member which may be configured to be arranged in an open state and a closed state, a cavity which may be formed between the first half shell member and the second half shell member when the outer shell may be in the closed state, the cavity may be shaped to receive a cutter blade assembly of the cutting tool therein, and first and second locking portions which may secure the first half shell member to the second half shell member when the outer shell may be in the closed state. The cavity may be shaped to allow the cutter blade assembly of the cutting tool to move between fully opened and fully closed positions inside the outer shell.

### TECHNICAL FIELD

Example embodiments generally relate to hand tools, and more particularly, relate to a cutting tool having an operation prevention device.

### BACKGROUND

A number of hand tools are designed to cut through material. Bolt cutters are one example of a hand tool used for cutting through materials such as bolts, chains, wire mesh, and padlocks. They are widely used in many occupations, such as construction, mechanics, security and law enforcement. Bolt cutters are also used in a variety of applications, from cutting through locks and chains to cutting through wire fencing. They are often used to gain access into locked areas or forcibly remove padlocks. They can also be used to cut wires for electrical work, as well as cutting through metal and plastic pipes.

Recently there has been a rise in the use of cutting tools to aid in the theft of merchandise from hardware stores. In many cases, a thief in a store may use the cutting tool that are on sale in one aisle to cut security measures off of other merchandise located elsewhere in the store. The cutting tool may then be returned to its respective aisle and the merchandise that has had its security measures removed may become easier to steal. This trend has led stores to chain up their cutting tools to reduce the likelihood of them being used to aid in the theft of other merchandise. However, this current solution doesn't inhibit the operation of the cutting tools and still allows the cutting tools to be used to cut off the security measures on other merchandise. Additionally, some customers may buy cutting tools, use them, and then return them. Therefore, it may be desirable to create a solution to combat these trends.

### BRIEF SUMMARY OF SOME EXAMPLES

Some example embodiments may provide for an operation prevention device for a cutting tool. The operation prevention device may include an outer shell having a first half shell member and a second half shell member which may be configured to be arranged in an open state and a closed state, a cavity which may be formed between the first half shell member and the second half shell member when the outer shell may be in the closed state, the cavity may be shaped to receive a cutter blade assembly of the cutting tool therein, and first and second locking portions which may secure the first half shell member to the second half shell member when the outer shell may be in the closed state. The cavity may be shaped to allow the cutter blade assembly of the cutting tool to move between fully opened and fully closed positions inside the outer shell.

Some example embodiments may provide for an operation prevention device for a cutting tool. The operation prevention device may include a stopper removably operably coupleable to a cutter blade assembly of the cutting tool. The stopper may include a body having a first face, a second face, a third face, a fourth face, a fifth face and a sixth face. When the stopper may be operably coupled to the cutter blade assembly, the first and third faces may engage first and second jaws, respectively, of the cutter blade assembly to inhibit movement of the first and second jaws. The stopper may further include a first flange, a second flange, and a third flange to operably couple the stopper to the cutter blade assembly.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a cutting tool fitted with an operation prevention device according to an example embodiment;

FIG. 2a illustrates a close up left side view of the cutting tool with jaws closed and fitted with the operation prevention device in accordance with an example embodiment;

FIG. 2b illustrates a close up left side view of the cutting tool with jaws open and fitted with the operation prevention device in accordance with an example embodiment;

FIG. 3 illustrates a close up perspective view of the cutting tool fitted with the operation prevention device according to an example embodiment;

FIG. 4 illustrates an isolated perspective view of the operation prevention device according to an example embodiment;

FIG. 5 illustrates a close up perspective view of the operation prevention device hinge taken from box 5 in FIG. 4 according to an example embodiment;

FIG. 6 illustrates an isolated perspective view of the operation prevention device in the closed state according to an example embodiment;

FIG. 7 illustrates an isolated perspective view of the operation prevention device in the open state according to an example embodiment;

FIG. 8 illustrates a perspective view of the operation prevention device in the open state with the cutting tool according to an example embodiment;

FIG. 9 illustrates a side view of the operation prevention device in the open state with the cutting tool according to an example embodiment;

FIG. 10 illustrates a perspective view of the operation prevention device according to an example embodiment;

FIG. 11 illustrates a perspective view of the operation prevention device according to an example embodiment;

FIG. 12 illustrates a perspective view of the operation prevention device according to an example embodiment;

FIG. 13 illustrates a perspective view of the operation prevention device according to an example embodiment;

FIG. 14 illustrates a close up perspective view of the cutting tool fitted with the operation prevention device according to an example embodiment;

FIG. 15 illustrates a close up perspective view of the cutting tool fitted with the operation prevention device according to an example embodiment;

FIG. 16 illustrates a close up right side view of the cutting tool fitted with the operation prevention device according to an example embodiment;

FIG. 17a illustrates a close up perspective view of the operation prevention device according to an example embodiment;

FIG. 17b illustrates a close up perspective view of the operation prevention device according to an example embodiment;

FIG. 18 illustrates a close up perspective view of the cutting tool fitted with the operation prevention device according to an example embodiment;

FIG. 19 illustrates a close up perspective view of the operation prevention device being inserted into the cutting tool according to an example embodiment;

FIG. 20 illustrates a close up perspective view of the cutting tool fitted with the operation prevention device according to an example embodiment;

FIG. 21 illustrates a close up perspective view of the cutting tool fitted with the operation prevention device according to an example embodiment;

FIG. 22 illustrates a close up left side view of the cutting tool fitted with the operation prevention device according to an example embodiment;

FIG. 23 illustrates a close up perspective view of the cutting tool fitted with the operation prevention device according to an example embodiment;

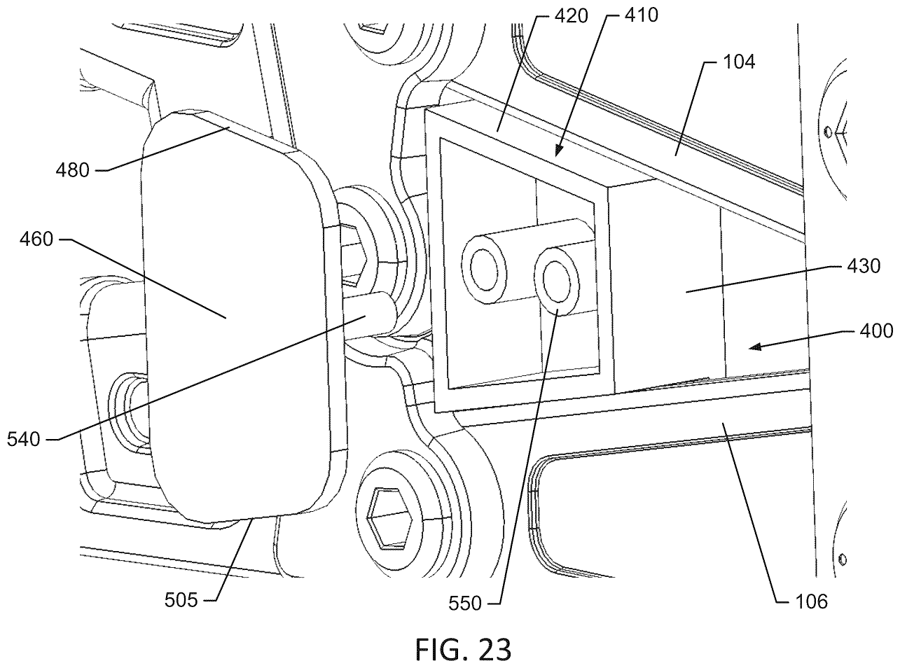

FIG. 24 illustrates a close up perspective view of the operation prevention device according to an example embodiment;

FIG. 25 illustrates a close up perspective view of the cutting tool fitted with the operation prevention device according to an example embodiment; and

FIG. 26 illustrates a close up perspective view of the operation prevention device according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may therefore provide an operation prevention device for cutting tools that may prevent the operation/use of the cutting tools, but that may also visually indicate if the cutting tools have been used prior to being returned. In one example embodiment, the operation prevention device may surround a cutter blade assembly of the cutting tools while allowing the cutter blade assembly to move within the device via the handles, without altering the operation prevention device in any way. In this regard, potential buyers of the cutting tools can still see how the cutter blade assembly moves while the cutting tools are prevented from being used to cut anything. In another example embodiment, the operation prevention device may include a stopper disposed between jaws of the cutting tools. The stopper may be locked in place to prevent the cutting tools from being able to open, which in turn also prevents the cutting tools from being used to cut anything. In either case, the operation prevention device may show evidence of being tampered with in the event that the cutting tools are purchased, used and then returned. Accordingly, the likelihood of the cutting tools being used to remove security measures from other merchandise may be reduced.

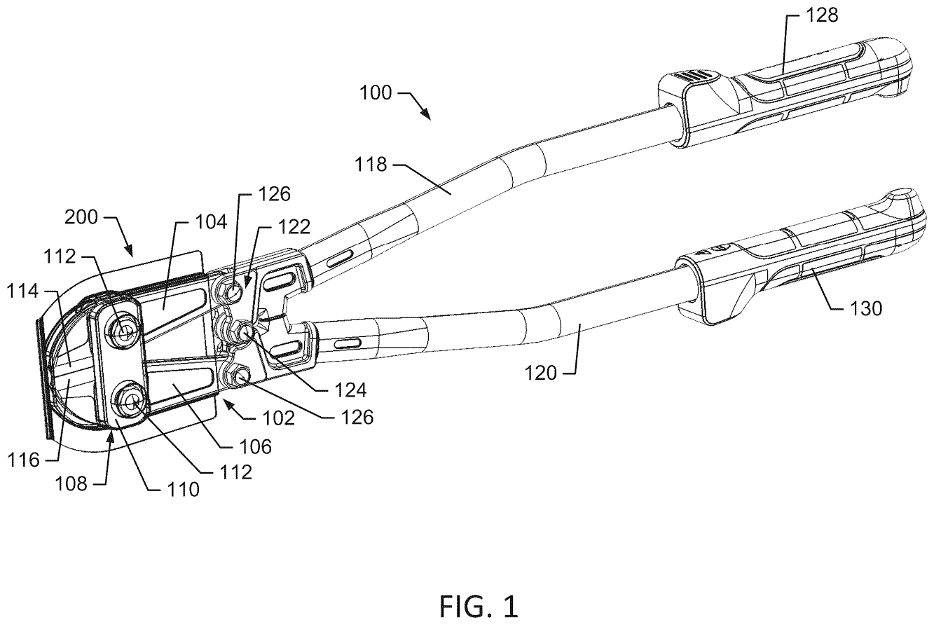

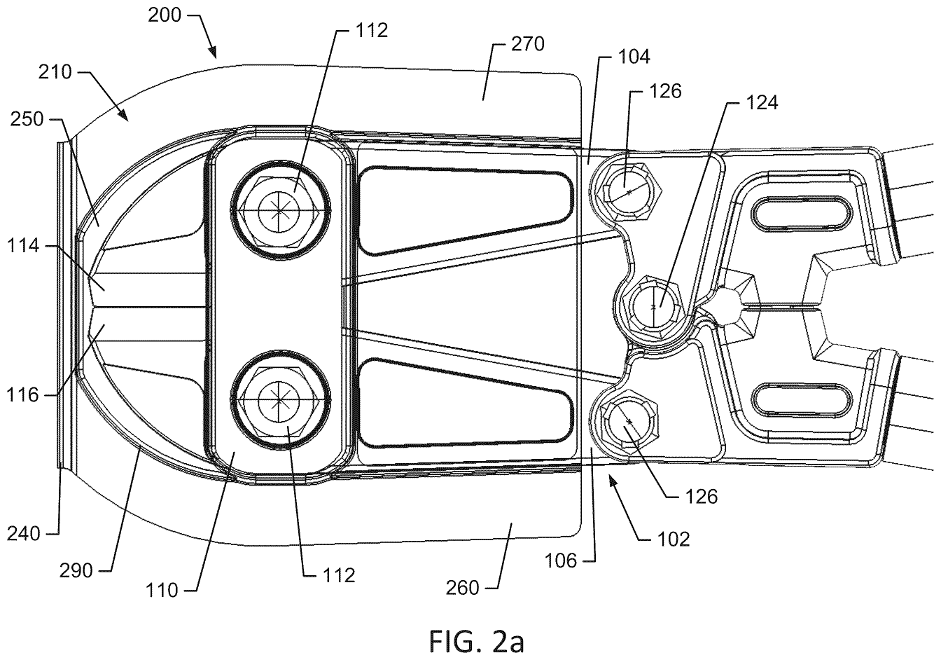

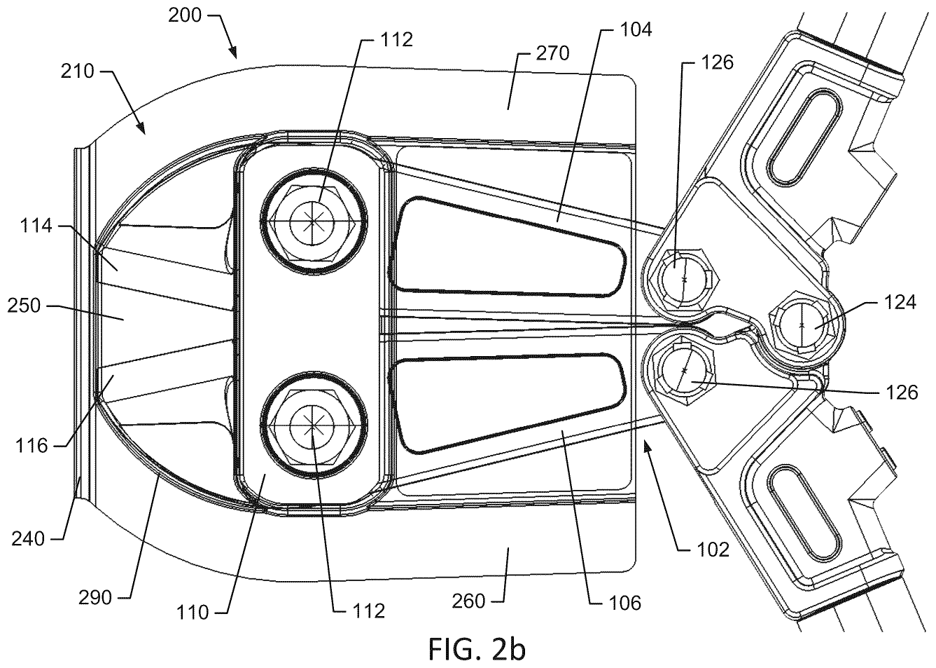

Referring now to FIGS. 1-2b, FIG. 1 illustrates a cutting tool 100 according to some example implementations of the present disclosure. In FIGS. 1 and 2a, the cutting tool 100 is shown in a fully closed position, and in FIG. 2b, the cutting tool 100 is shown in a fully open position. In an example embodiment, the cutting tool 100 may be bolt cutters. In other cases, the cutting tool 100 may be wire crimpers, yard trimmers, loppers, shears, pruners, aviation snips, scissors, or other similar types of cutting tool 100. As shown, the cutting tool 100 may include a cutter blade assembly 102 with a pair of jaws. In particular, the blade assembly 102 may include a first jaw 104 and a second jaw 106 that may be pivotably secured to one another at a jaw joint 108 by plates 110 and fasteners 112 such as bolts. The first jaw 104 may include a first cutting blade 114 disposed at working end thereof, and similarly the second jaw 106 may include a second cutting blade 116 disposed at the working end thereof. The first and second cutting blades (114, 116) may be the cutting surfaces of the cutting tool 100, and may be structured in a number of different manners for a number of different uses.

The cutting tool 100 may also include a pair of handle assemblies, namely a first handle 118 and a second handle 120. The first and second handles (118, 120) may be pivotably connected to one another, and pivotably connected to the cutter blade assembly 102. In this regard, the cutting tool 100 may include a compound hinge arrangement of hinge joints and levers that may allow a user to exert more force on the first and second cutting blades (114, 116) with less effort. As shown, the cutting tool 100 may include a pivot assembly 122 that may define a handle joint and a middle joint. The first and second handles (118, 120) may be pivotably connected to one another at the handle joint by a fastener 124 (e.g., bolt). Similarly, the first and second jaws 104, 106 of the cutter blade assembly 102 may be pivotably connected to the first and second handles (118, 120) by fasteners 126 (e.g., bolts). Accordingly, the cutter blade assembly 102 may be movable via the pivot assembly 122 between a fully closed position and a fully open position. In the fully closed position depicted in FIGS. 1 and 2a, the first cutting blade 114 may be in contact with the second cutting blade 116. On the other hand, in the fully open position depicted in FIG. 2b, the first and second cutting blades (114, 116) may not be in contact with each other and may instead be angled away from each other.

As also shown, the cutting tool 100 may further include a handle grip fitted onto a free end of each handle assembly, opposite the cutter blade assembly 102. In particular, the cutting tool 100 may include a first handle grip 128 fitted onto the free end of the first handle 118, and a second handle grip 130 fitted onto the free end of the second handle 120. Each handle grip may include a butt-end, and an open end opposite the butt-end from which one of the handle assemblies may extend. Each handle grip may also include a grip body with a curved surface configured to be gripped by a user.

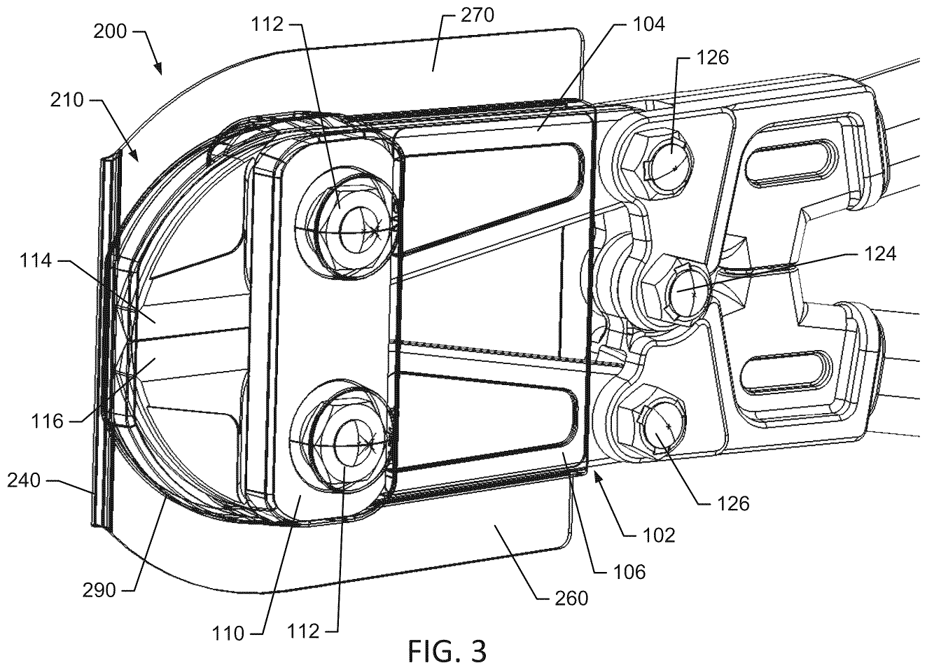

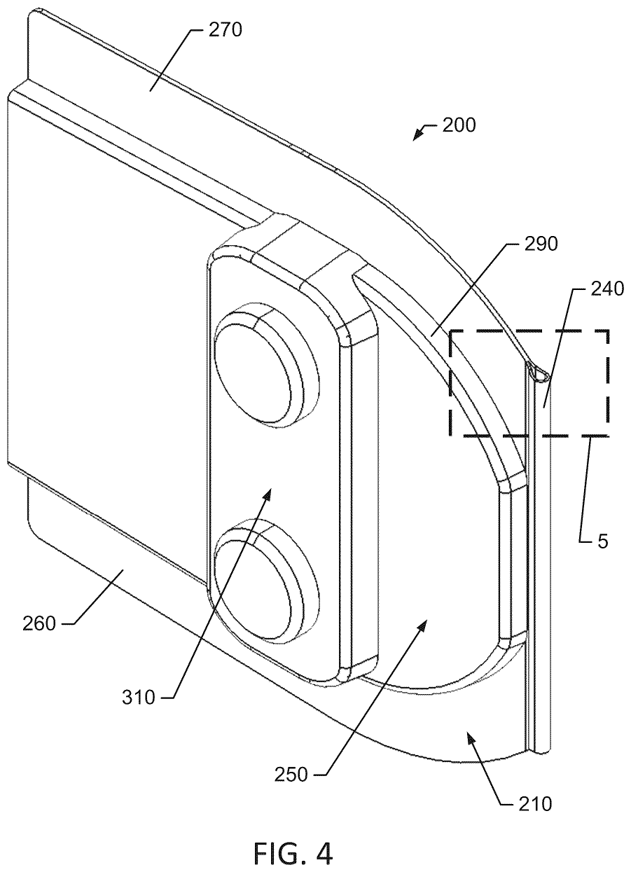

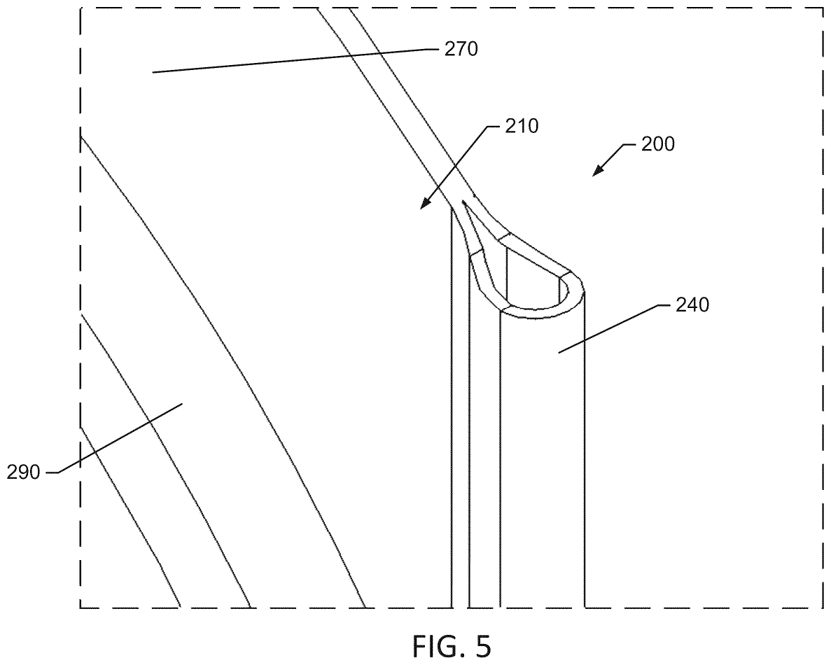

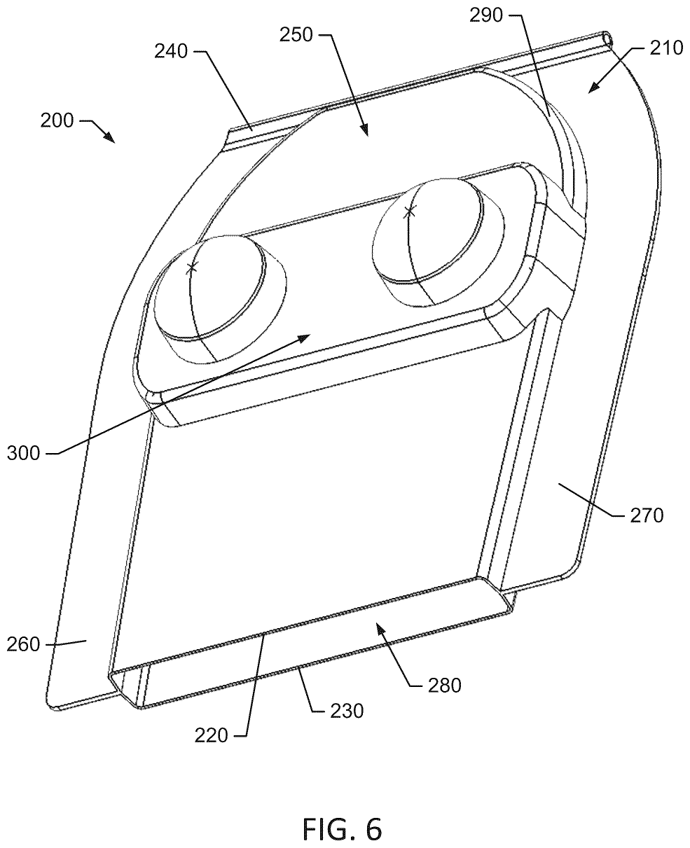

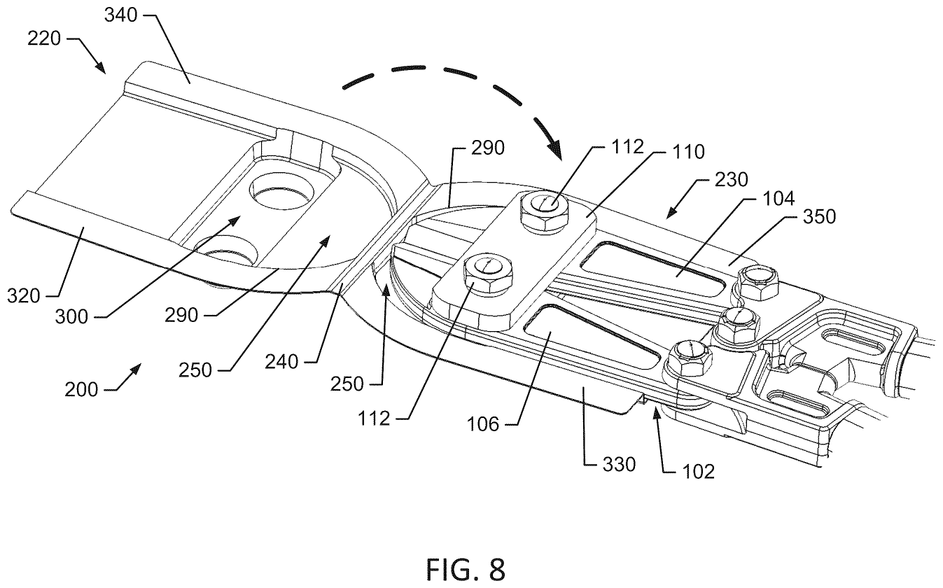

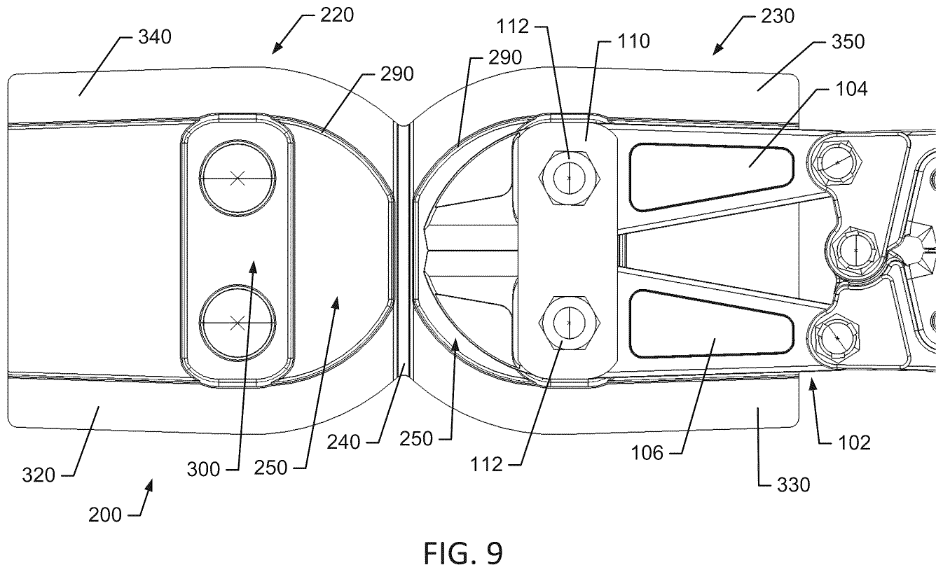

As discussed above, in some cases, the cutting tool 100 may be fitted with an operation prevention device 200. In some example embodiments, such as the one depicted in FIGS. 1-11, the operation prevention device 200 may be disposed around the cutter blade assembly 102 to prevent the cutter blade assembly 102 from being used to cut anything while the operation prevention device 200 is disposed on the cutting tool 100. The operation prevention device 200 of the embodiment shown in FIGS. 1-11 may, however, allow for the cutter blade assembly 102 to be moved within the operation prevention device 200 without removing the operation prevention device 200 from the cutting tool 100. In this regard, a user or operator handling the cutting tool 100 fitted with the operation prevention device 200 may view the movement of the cutter blade assembly 102 through the operation prevention device 200 to evaluate if the cutting tool 100 will function adequately for their needs. As such, the operation prevention device 200 may be entirely or partially formed from a transparent material that may allow the cutter blade assembly 102 to be viewed through the operation prevention device 200.

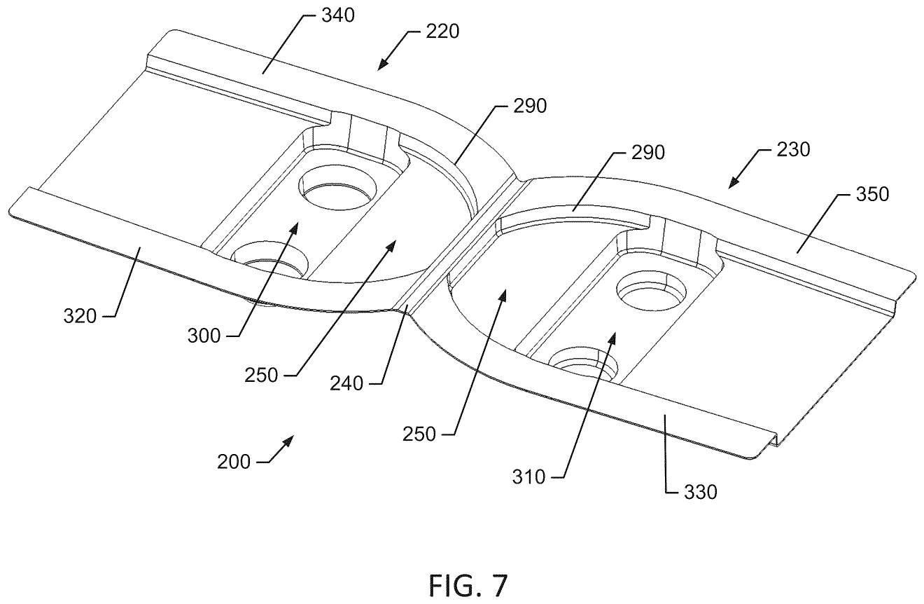

Referring now to FIGS. 1-11, the operation prevention device 200 may include an outer shell 210 which may have a first half shell member 220 and a second half shell member 230. The operation prevention device 200 may further include a hinge 240 operably coupling the first half shell member 220 to the second half shell member 230. The first half shell member 220 and the second half shell member 230 may be rotatable relative to each other about the hinge 240 to transition the outer shell 210 from an open state (e.g. FIGS. 7-9) to a closed state (e.g. FIGS. 1-6 and 10). The operation prevention device 200 may also include a cavity 250 formed between the first half shell member 220 and the second half shell member 230 when the outer shell 210 may be in the closed state. In some cases, the cavity 250 may be shaped to receive the cutter blade assembly 102 of the cutting tool 100 therein. Furthermore, the operation prevention device 200 may also include first and second locking portions (260, 270) to secure the first half shell member 220 to the second half shell member 230 when the outer shell 210 may be in the closed state. As mentioned above, the cutter blade assembly 102 may be movable within the operation prevention device 200, and in this regard, the cavity 250 may be shaped to permit the movement of the cutter blade assembly 102 along its full range of motion inside the outer shell 210. In other words, the cavity 250 may be shaped to allow the cutter blade assembly 102 of the cutting tool 100 to move between fully opened and fully closed positions inside the outer shell 210.

The operation prevention device 200 of an example embodiment may operably couple to the cutting tool 100 in a non-removable manner. In this regard, the operation prevention device 200 may be removed from the cutting tool 100 by destroying the operation prevention device 200 such that the operation prevention device 200 may not be re-fitted onto the cutting tool 100 after being removed from the cutting tool 100. This may have the effect of visually signaling to the user or operator whether or not the operation prevention device 200 and/or the cutting tool 100 has been removed, opened or tampered with without their knowledge or by a previous user or operator. As such, to operably couple the operation prevention device 200 to the cutting tool 100, the outer shell 210 may first be in the open state with the first and second half shell members (220, 230) laid out with their respective parts of the cavity 250 open to receive the cutter blade assembly 102. With the outer shell 210 in the open state, the cutter blade assembly 102 of the cutting tool 100 may be laid into one of either of the first or second half shell members (220, 230). The other (empty) one of the first or second half shell members (220, 230) may then be rotated relative to each other about the hinge 240 to transition the outer shell 210 from the open state to the closed state. With the first and second half shell members (220, 230) now folded on top of one another, the first and second shell members (220, 230) may be scaled together at the first and second locking portions (260, 270) disposed on opposing sides of the cavity 250 from each other. This will be described in more detail below with respect to further structures of the operation prevention device 200.

In some cases, the cavity 250 may include an opening 280 formed between the first half shell member 220 and the second half shell member 230. The opening 280 may function as a passageway between the inside of the cavity 250 and the operation prevention device 200 to outside the cavity 250 and the operation prevention device 200. In this regard, with the operation prevention device 200 disposed on the cutting tool 100, the first jaw 104 and the second jaw 106 may extend through the opening 280. The opening may be elongated along a width of the operation prevention device 200 to allow room for the first and second jaws (104, 106) to move along the entire range of motion of the cutter blade assembly 102. In some example embodiments, the opening 280 may be substantially rectangular and may be defined between the first and second locking portions (260, 270) when the operation prevention device 200 is in the closed state.

In an example embodiment, the cavity 250 may further include an arcuate profile 290 disposed proximate to the hinge 240. The first and second jaws (104, 106) may extend into the cavity 250 through the opening 280 and to the arcuate profile 290. The first and second cutting blades (114, 116) may be disposed at the distal end of the first and second jaws (104, 106), respectively, and may be disposed within the arcuate profile 290 of the cavity 250. In this regard, the arcuate profile 290 may be shaped to accommodate the first and second cutting blades (114, 116) in their entire range of motion. For instance, with the cutting tool 100 closed and the first and second cutting blades (114, 116) contacting each other, there may be empty space between the arcuate profile 290 and a back edge (i.e. non-cutting edge, opposite the first and second cutting blades (114, 116)) of the first and second jaws (104, 106). However, with the cutting tool 100 open as wide as the first and second jaws (104, 106) may allow, the empty space between the first and second jaws (104, 106) and the arcuate profile 290 may be filled. (See FIGS. 2a and 2b). As such, the first and second cutting blades (114, 116) may be movable within the arcuate profile 290 of the cavity 250 responsive to movement of first and second handles (118, 120) of the cutting tool 100, without removing the operation prevention device 200 from the cutting tool 100.

The cavity 250 may also include a first recessed portion 300 formed in the first half shell member 220 and a second recessed portion 310 formed in the second half shell member 230. The first and second recessed portions (300, 310) of the cavity 250 may be sized and shaped to receive the jaw joint 108 therein when the operation prevention device 200 is in the closed state. In this regard, the first recessed portion 300 may be shaped to receive a first side of the plates 110 and fasteners 112 while the second recessed portion 310 may be shaped to receive a second side of the plates 110 and fasteners 112. This way, when the first half shell 220 is folded over onto the second half shell member 230, the first and second recessed portions (300, 310) may align with the plates 110 and fasteners 112 accordingly to ensure proper fitment of the cutter blade assembly 102 within the cavity 250. In some cases, the cutter blade assembly 102 may not be removable from the cavity 250 through the opening 280 due to the corresponding structures (e.g. plates 110 and fasteners 112) of the cutter blade assembly 102 being disposed in respective ones of the first and second recessed portions (300, 310). In other words, the thickness of the cavity 250 at the first and second recessed portions (300, 310) may be greater than the thickness of the cavity 250 at the opening 280, and as such, the cutter blade assembly 102 may not fit to slide out of the cavity 250 through the opening 280.

In an example embodiment, the outer shell 210 may include one continuous piece of material that may be formed into the first half shell member 220, the hinge 240 and the second half shell member 230. In some cases, the outer shell 210 may be formed from a plastic or polymer type material via a molding process. In this regard, the operation prevention device 200 may be molded in the open state to increase manufacturing efficiency of the operation prevention device 200. In an example embodiment, the hinge 240 may include a malleable portion of material integrally formed from the first and second half shell members (220, 230). In this regard, the hinge 240 may include a thin section of material disposed between the first and second half shell members (220, 230). The hinge 240 may be able to be folded without breaking the material of the hinge 240 so that the operation prevention device 200 remains one continuous piece of material in both the open and closed states, and so that the hinge 240 may form a section of the edge of the operation prevention device 200 when in the closed state. In the open state, the first half shell member 220 and the second half shell member 230 may be integrally operably coupled together only by the hinge 240. In other cases, other materials may be used to form the operation prevention device 200 and by other processes as well. In an example embodiment, the material of the operation prevention device 200 is a transparent material, capable of showing the cutter blade assembly 102 through the operation prevention device 200. In some other cases, the first and second half shell members (220, 230) may be formed as separate pieces and not joined by the hinge 240. In such an example, the operation prevention device 200 may further include a third locking portion proximate to the arcuate profile 290 to seal off the cavity 250.

In some cases, the first locking portion 260 may include a first flap 320 disposed at the first half shell member 220, and a second flap 330 disposed at the second half shell member 230. Similarly, the second locking portion 270 may include a third flap 340 disposed at the first half shell member 220, and a fourth flap 350 disposed at the second half shell member 230. Accordingly, in the closed state, the first and second flaps (320, 330) may operably couple together and the third and fourth flaps (340, 350) may operably couple together. In some cases, the flaps (320, 330, 340, 350) may be adhered to one another using an adhesive applied to the respective contacting surfaces of the first, second, third and fourth flaps (320, 330, 340, 350). In an example embodiment, the respective flaps (320, 330, 340, 350) may be pressed together while heat may be applied to the first and second locking portions (260, 270) to seal the first and second flaps (320, 330) together and the second and third flaps (340, 350) together. In some cases, the first and second locking portions (260, 270) may be sealed together using alternative methods and/or structures to the ones described herein. In any case, the operation prevention device 200 may have three of its four edges sealed off from the outside: the hinge 240, the first locking portion 260, and the second locking portion 270. The fourth edge may include the opening 280, which as discussed previously, may be open to allow the first and second jaws (104, 106) to extend out of the cavity 250.

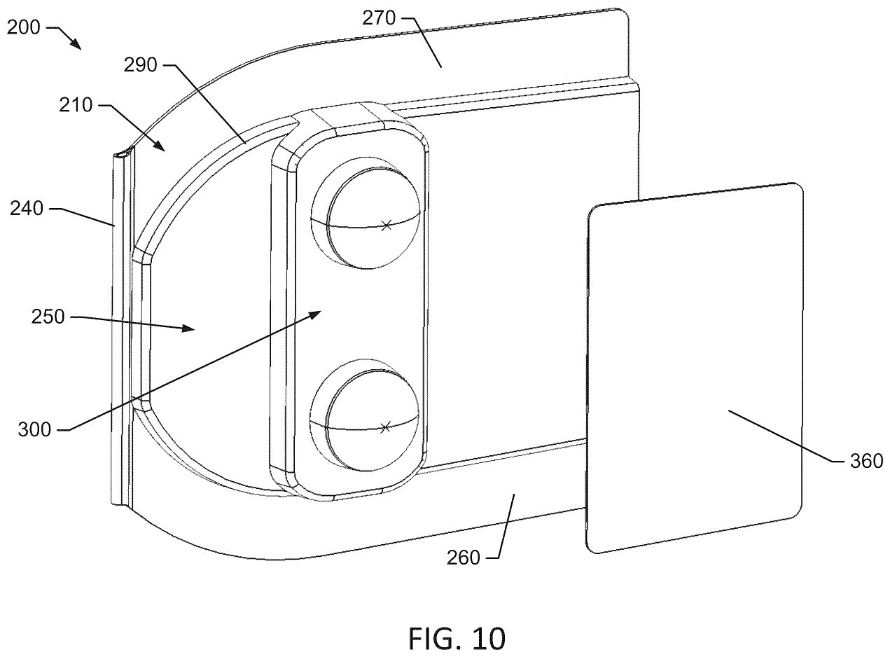

As shown in FIG. 10, in some cases, the operation prevention device 200 may have a label 360 operably coupled to the outer shell 210. The label 360 may be used to display marketing material, operation specifications about the cutting tool 100, or other text or images for a plurality of purposes. In an example embodiment, the label 360 may be adhered to an exterior of the outer shell 210, and may not inhibit the user or operator from visualizing the first and second cutter blades (114, 116) through the outer shell 210 at the arcuate profile 290. In some cases, the operation prevention device 200 may also include a hang hole disposes therethrough. The hang hole may enable the cutting tool 100 to be hung from a merchandise shelf or rack via the operation prevention device 200.

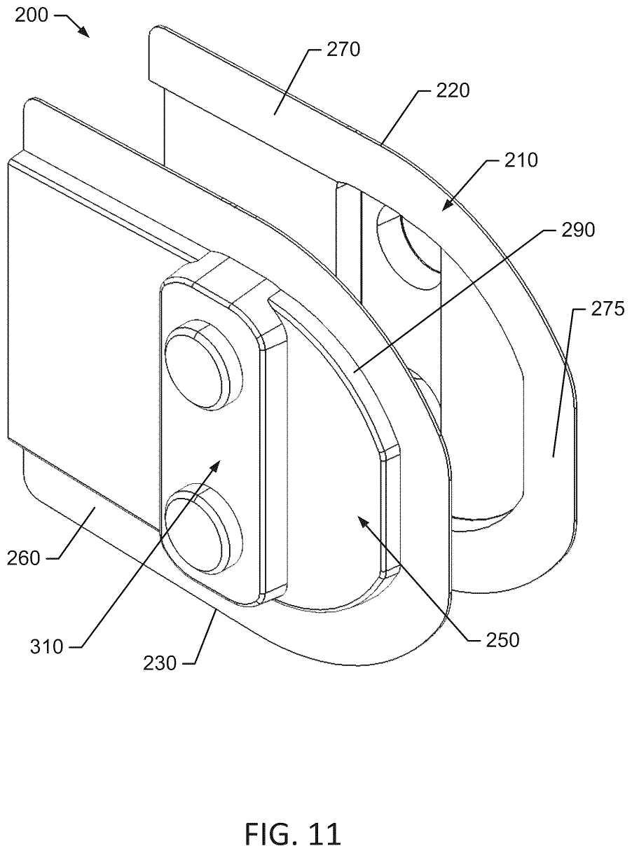

FIG. 11 depicts an example embodiment of the operation prevention device 200 in which the first and second half shell members (220, 230) may not be formed from a single piece of material and thus may not be joined at the hinge 240. In this regard, the first and second half shell members (220, 230) may be formed separately from one another and may be independent, yet complementary, components. In some cases, the operation prevention device 200 may include a third locking portion 275 that may be disposed between the first and second locking portions (260, 270) that may enclose the cavity 250. A such, the outer shell 210 may be assembled on the cutting tool 100 not by rotating the first half shell member 220 onto the second half shell member 230 about the hinge 240, but instead by aligning the first, second and third locking portions (260, 270, 275) and sealing their respective flaps together. In some cases, this construction of the operation prevention device 200 may be referred to as a two piece (or double) blister where the first and second half shell members (220, 230) are the two pieces and they are operably coupled to one another via the blister without the hinge 240. The two piece blister construction shown in FIG. 11 may still provide all the same functions of the operation prevention device 200 described above in reference to the hinged outer shell 210.

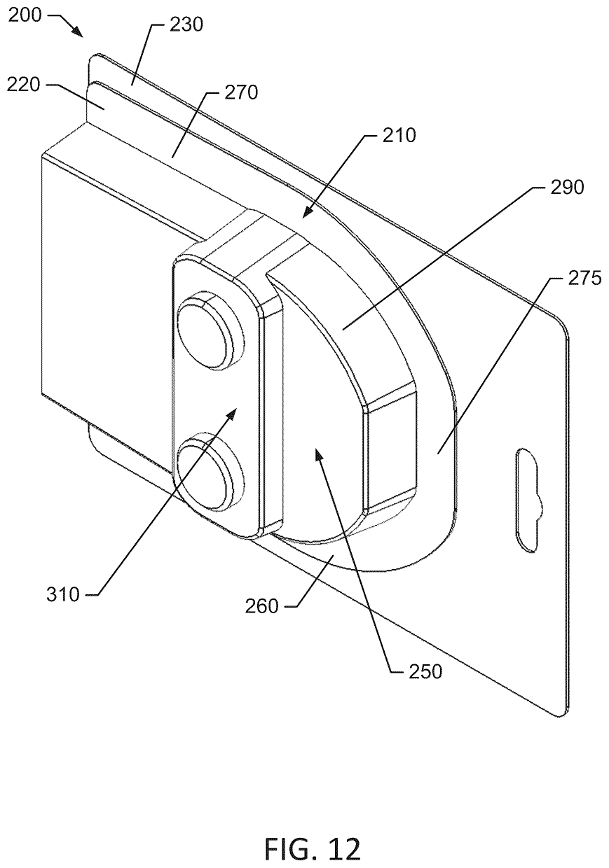

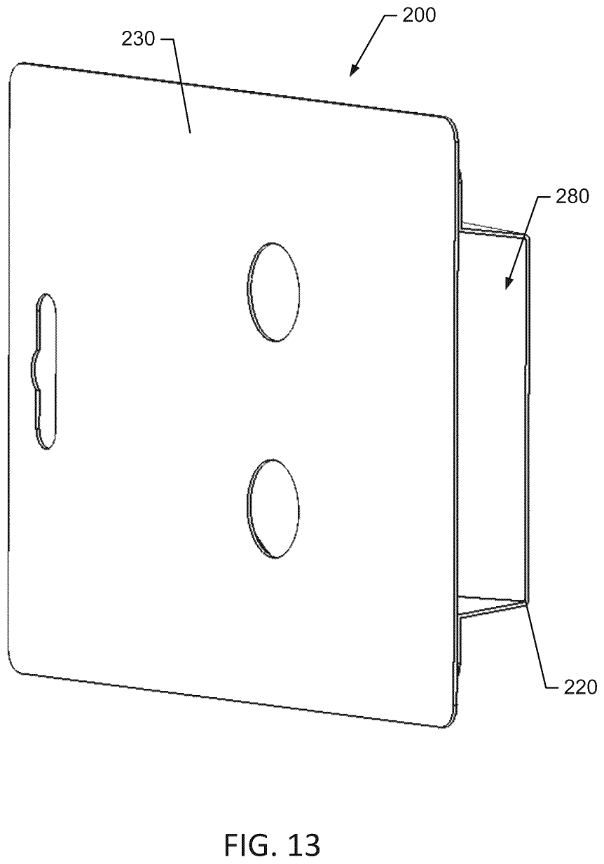

FIGS. 12 and 13 illustrate an example embodiment of the operation prevention device 200 in which the first and second half shell members (220, 230) may not have the same shape as each other. In this regard, the operation prevention device 200 may be constructed in a face seal blister configuration. In other words, the first half shell member 220 may be created with a deeper cavity 250 to receive the cutting tool 100 therein. The second half shell member 230 may be substantially planar. The first half shell member 220 may operably couple to the second half shell member 230 via the first, second and third locking portions (260, 270, 275). In the embodiment shown in FIGS. 12 and 13, the second half shell member 230 may, in some cases, be operably coupled to an insert that may be used for similar purposes as the label 360 described previously. In this regard, the insert may sit flat against the second half shell member 230 and behind the cutting tool 100 in the operation prevention device 200. In some cases, the second half shell member 230 may include a pair of holes through the second half shell member 230 which may align with the fasteners 112 and allow the cutting tool 100 to fit within the cavity 250. The face seal blister construction shown in FIGS. 12 and 13 may still provide all the same functions of the operation prevention device 200 described above in reference to the hinged outer shell 210. As mentioned above, the difference in the embodiment of FIGS. 12 and 13 may be the cavity 250 is deeper in the first half shell member 220 so that the second half shell member 230 may be planar and the cutting tool 100 may still be retained in the cavity 250.

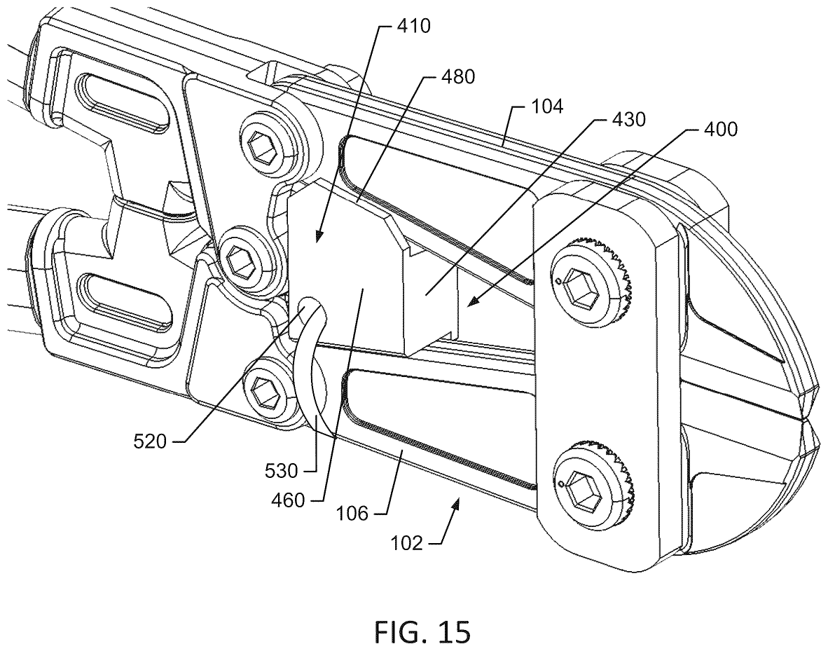

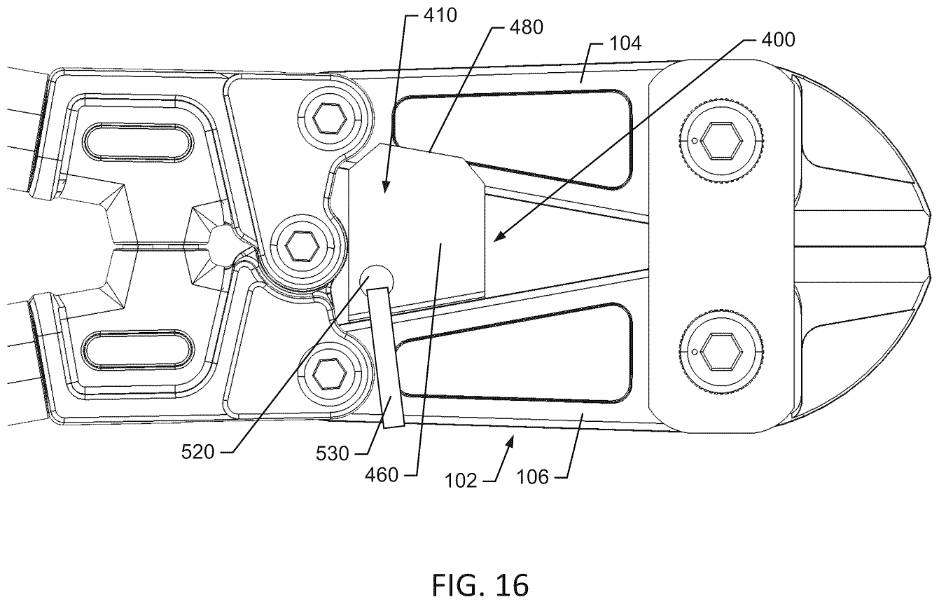

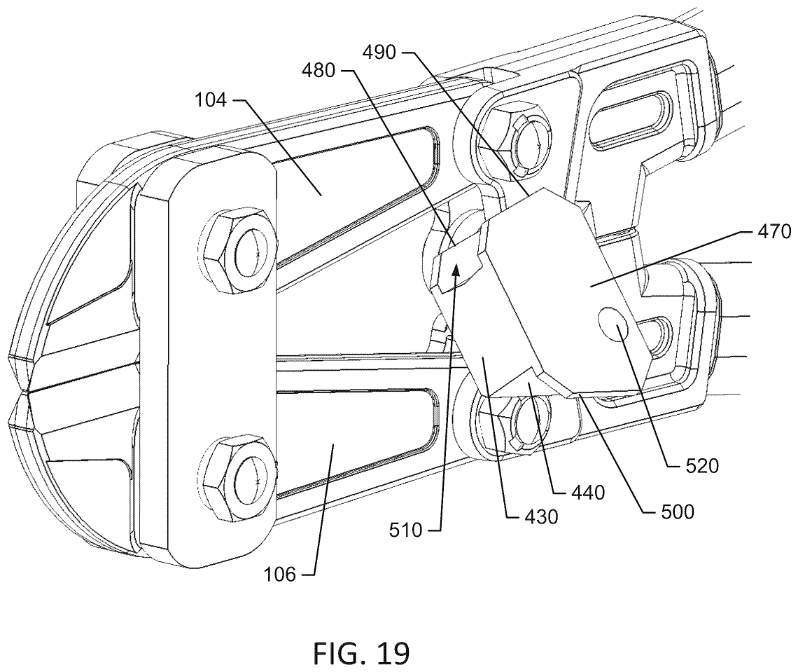

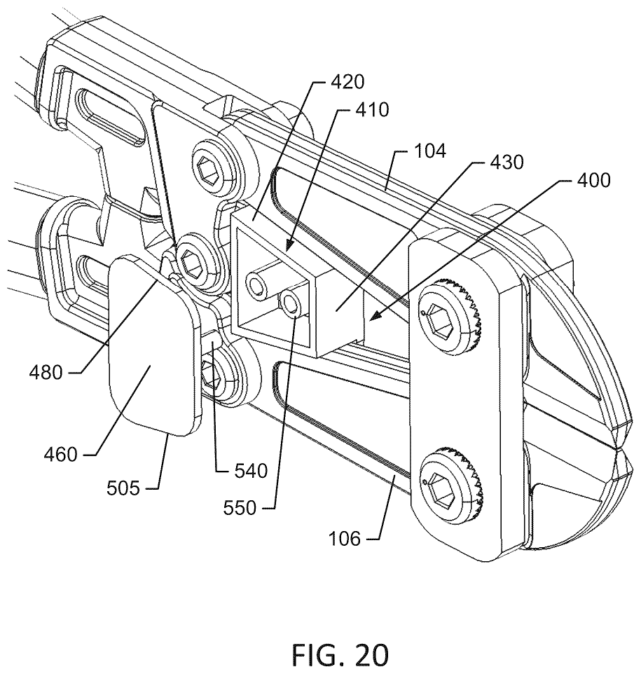

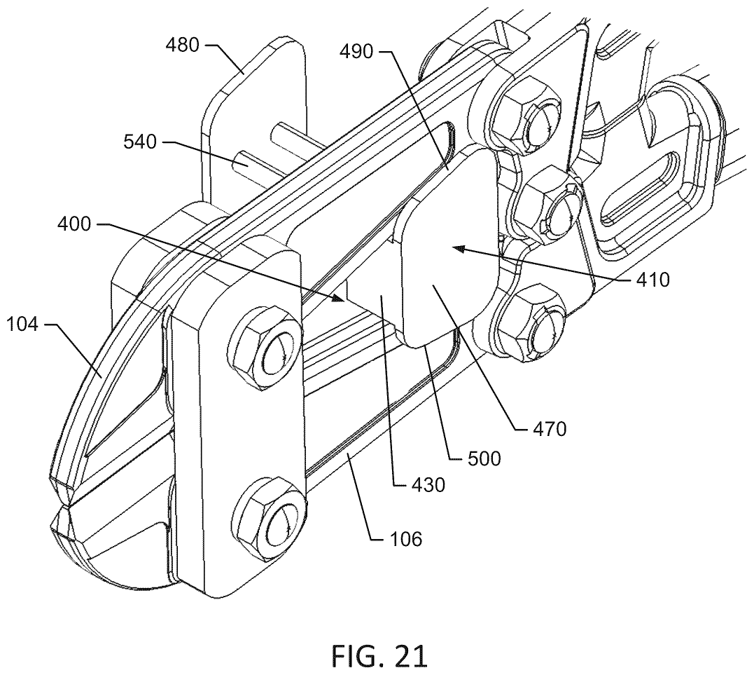

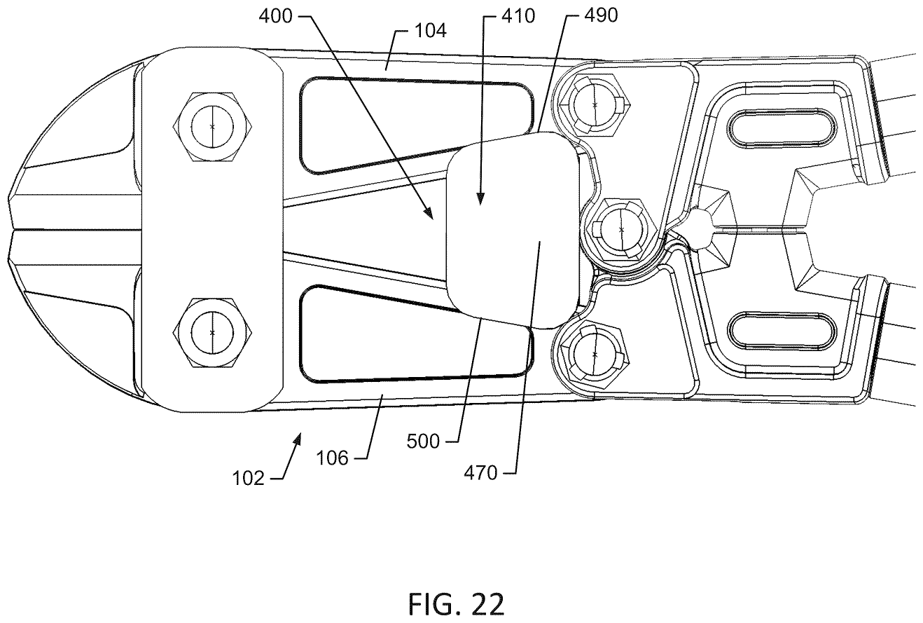

Referring now to FIGS. 12-22, a second embodiment of the operation prevention device 400 may be shown and described. In the embodiment shown in FIGS. 12-22, the operation prevention device 400 may include a stopper 410 removably operably coupleable to the cutter blade assembly 102 of the cutting tool 100. Similar to the operation prevention device 200, the operation prevention device 400 may prevent the cutting tool 100 from being used to cut anything. Also similar to the operation prevention device 200, the operation prevention device 400 may have the effect of visually signaling to the user or operator whether or not the operation prevention device 400 and/or the cutting tool 100 has been removed, opened or tampered with without their knowledge or by a previous user or operator. Where the operation prevention device 400 may differ from the operation prevention device 200, however, is that the operation prevention device 400 may inhibit motion of the cutter blade assembly 102. In this regard, the stopper 410 may be locked in place in between the first jaw 104 and the second jaw 106 to prevent the cutting tool 100 from being able to open.

In an example embodiment, the stopper 410 may include a body having a first face 420, a second face 430, a third face 440, a fourth face 450, a fifth face 460 and a sixth face 470. In some cases, the stopper 410 may be a polyhedron, or in other words, a three dimensional shape having a plurality of faces. The stopper 410 may be shaped to fit snugly within the empty space immediately between the first and second jaws (104, 106) of the cutting tool 100. In this regard, when the stopper 410 may be operably coupled to the cutter blade assembly 102, the first and third faces (420, 440) may engage the first and second jaws (104, 106), respectively, of the cutter blade assembly 102 to inhibit movement of the first and second jaws (104, 106). The stopper 410 may further include a first flange 480, a second flange 490, and a third flange 500, which may operably couple the stopper 410 to the cutter blade assembly 102.

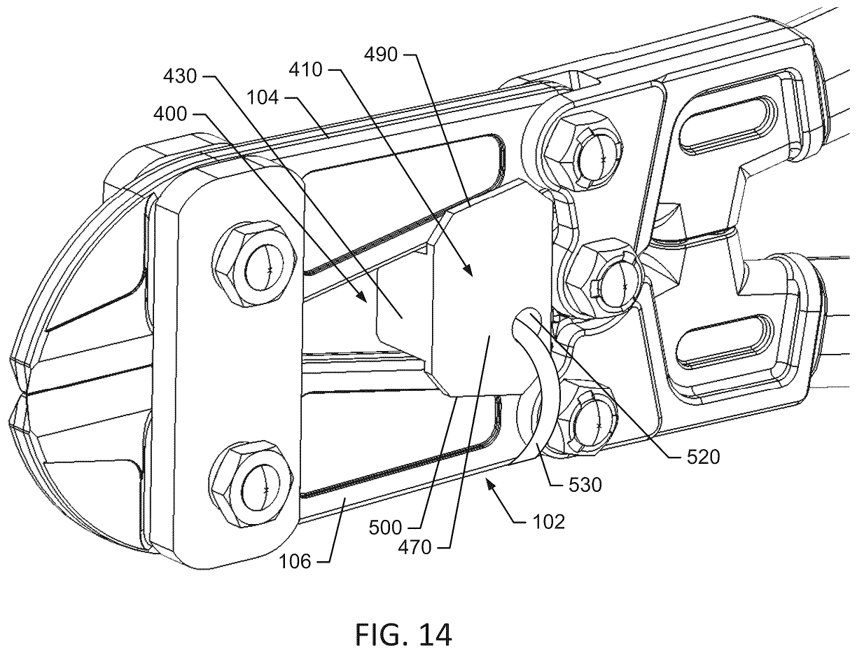

In some cases, the first and third faces (420, 440) may be angled relative to each other and may define an acute angle 425 therebetween. This angle may be substantially the same angle formed by the inner surfaces of the first and second jaws (104, 106) (see for example FIG. 14). By substantially matching the angle between the first and second jaws (104, 106), the stopper 410 may be able to securely operably couple to the cutter blade assembly 102 while inhibiting any motion of the first and second jaws (104, 106). In an example embodiment, the second and fourth faces (430, 450) may be planar and may be disposed in first and second planes (432, 452), respectively. The first and second planes (432, 452) may be substantially parallel to each other. In some cases, the fifth and sixth faces (460, 470) may also be planar and may be disposed in third and fourth planes (462, 472), respectively. In an example embodiment, the third and fourth planes (462, 472) may be substantially parallel to each other and substantially perpendicular to the first and second planes (432, 452). The first flange 480 may lie in the third plane 462 and the second and third flanges (490, 500) may lie in the fourth plane 472.

In this regard, the first and second flanges (480, 490) may extend on either side of, and away from, the first face 420. In other words, the first face 420 may be disposed between the first and second flanges (480, 490) which may extend parallel to each other and away from the first face 420. This particular shape may therefore form a first channel 510, in which the first jaw 104 may be disposed when the stopper 410 may be operably coupled to the cutter blade assembly 102. The first and second flanges (480, 490) may extend partially over the first jaw 104 so that the stopper 410 and the first jaw 104 remain aligned and in contact. In some cases, the first flange 480 and the second flange 490 may both contact the first jaw 104 on opposing sides of the first jaw 104. In some other cases, the first flange 480 may contact the first jaw 104 while the second flange 490 does not contact the first jaw 104, or vice versa. In still some other cases, neither of the first or second flanges (480, 490) may contact the first jaw 104. In any case, the first face 420 may contact the first jaw 104 to prevent the first jaw 104 from moving towards the second jaw 106. Similarly, the third face 440 may contact the second jaw 106 to prevent the second jaw 106 from moving towards the first jaw 104.

The third flange 500 may extend on one side of, and away from, the third face 440. In other words, the third face 440 may be disposed proximate and perpendicular to the third flange 500 which may extend parallel to the first flange 480 and coplanar with the second flange 490 and away from the third face 440. This particular shape may therefore form an L shape, in which the second jaw 106 may be disposed when the stopper 410 may be operably coupled to the cutter blade assembly 102. The third flange 500 may extend partially over the second jaw 106 so that the stopper 410 and the second jaw 106 remain aligned and in contact. In some cases, the third flange 500 may contact the second jaw 106, while in some other cases, the third flange 500 may not contact the second jaw 106.

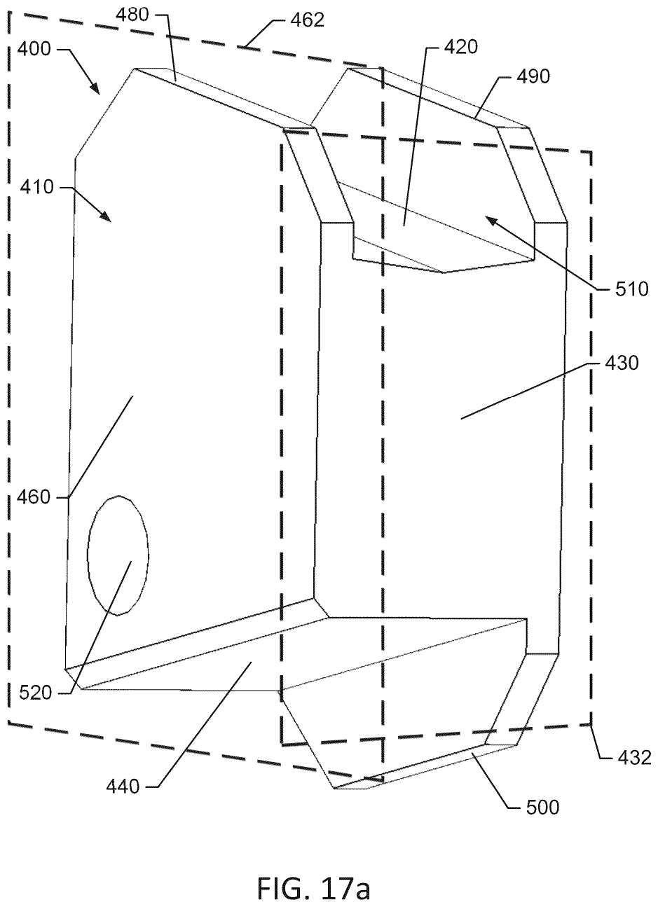

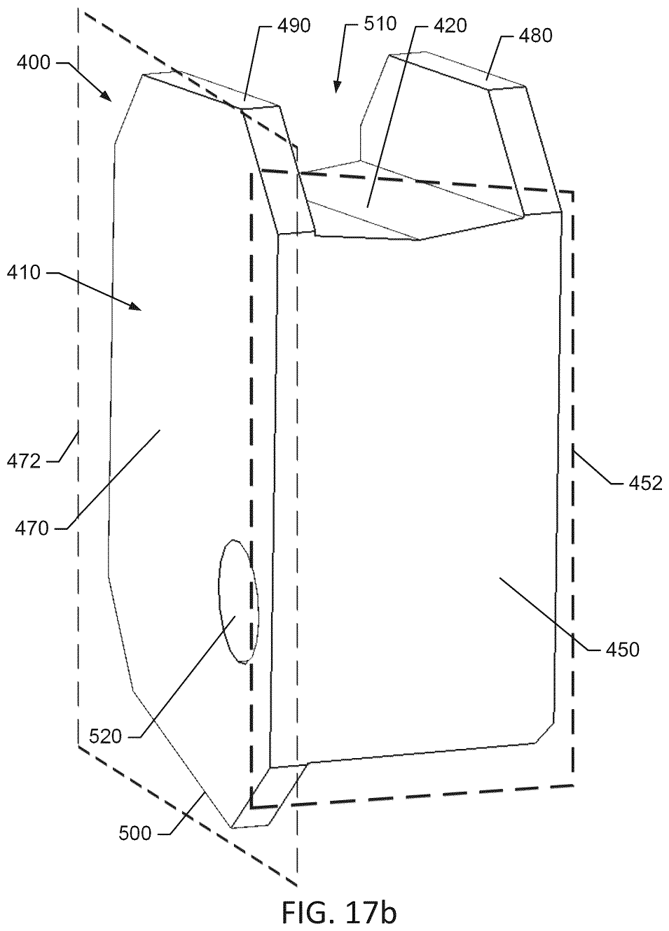

The shape of the stopper 410 with the first, second and third flanges (480, 490, 500) may increase the efficiency of installing the stopper 410. In this regard, as shown in FIG. 17, to install the stopper 410 in the cutting tool 100 without opening the cutting tool 100, first the stopper 410 must be tilted at an angle towards the first jaw 104. With the stopper 410 tilted, the stopper 410 may be moved in between the first and second jaws (104, 106) to where the first and second flanges (480, 490) are disposed on either side of the first jaw 104 and the first jaw 104 is disposed within the first channel 510. Then, the stopper 410 may be tilted back towards an upright orientation while retaining the first jaw 104 in the first channel 510. As such, the stopper 410 should be tilted back towards the upright position until the third flange 500 and the third face 440 contact the second jaw 106. Thus, not having a fourth flange may make it possible to install the stopper 410 without opening the cutting tool 100.

To securely operably couple the stopper 410 to the second jaw 106, the stopper 410 may further include a bore 520 that may extend perpendicularly to, and entirely through, the fifth face 460 and the sixth face 470 of the body. A locking member 530 may then be inserted through the bore 520, and around the second jaw 106 to securely operably couple the stopper 410 to the cutter blade assembly 102. In some cases, the locking member 530 may be an elastic band, a rigid ring like member, a cable tie, or any other suitable securing member.

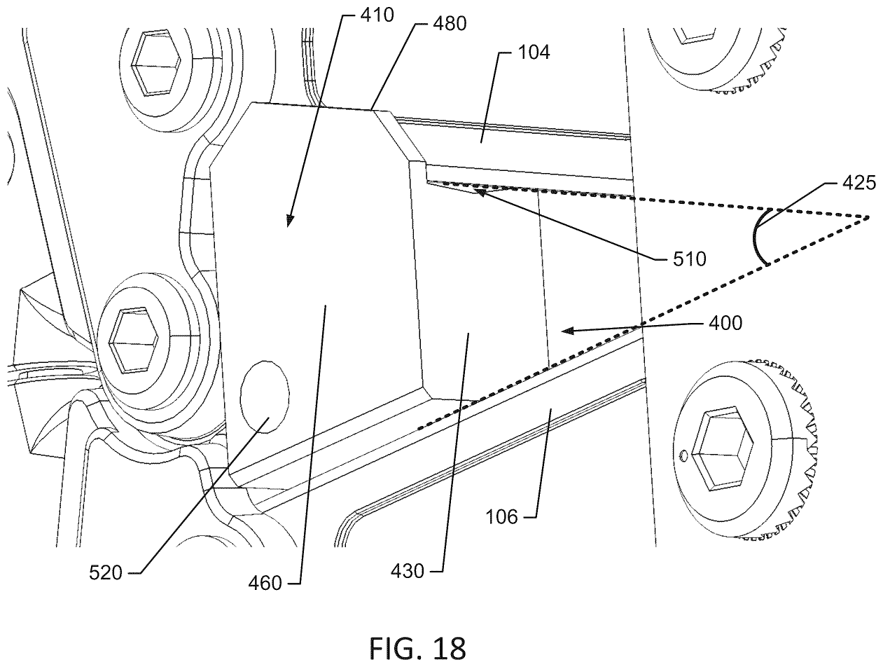

In the embodiment depicted in FIGS. 18-22, the stopper 410 may be formed as two separate components that operably couple to each other between the first and second jaws (104, 106). In this regard, the stopper 410 may still include the first, second, third, fourth, fifth and sixth faces (420, 430, 440, 450, 460, 470), but in this case, the fifth face 460 may be formed separate from the body. The fifth face 460 may include a fourth flange 505 that may lie in the third plane 462. In this regard, the third face 440, the third flange 500 and the fourth flange 505 may define a second channel 515 in which the second jaw 106 may be disposed when the stopper 410 may be operably coupled to the cutter blade assembly 102.

Accordingly, the first, second, third and fourth flanges (480, 490, 500, 505) may securely operably couple the stopper 410 to the cutter blade assembly 102. In some cases, the fifth face 460 may be operably coupled to the body via a snap fit. As such, the fifth face 460 may be formed with an attachment post 540 and the body of the stopper may be formed with an attachment receiver 550. In such cases, the fifth face 460 may be operably coupled to the stopper 410 by fitting the attachment post 540 into the attachment receiver 550, which may be held in place via a snap fit. Similar to the operation prevention device 200, the operation prevention device 400 may not be removable, so in this case, the attachment post 540 may not be removable from the attachment receiver 550. This may operably couple the fifth face 460 to the stopper 410 body such that the stopper 410 may inhibit the motion of the first and second jaws (104, 106).

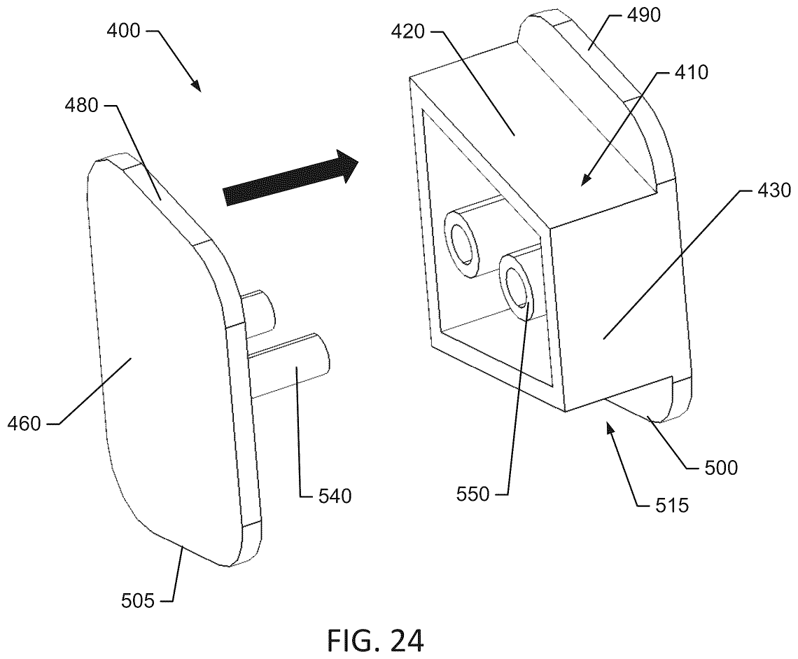

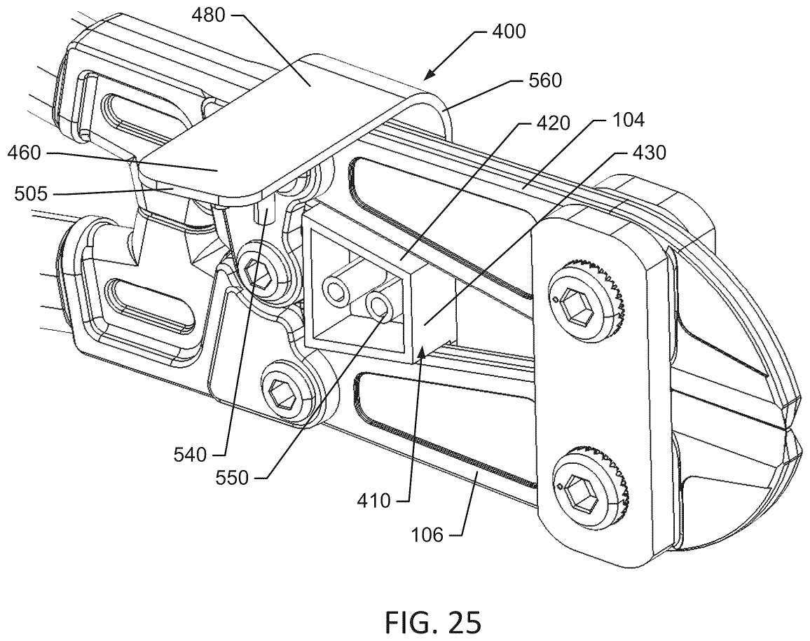

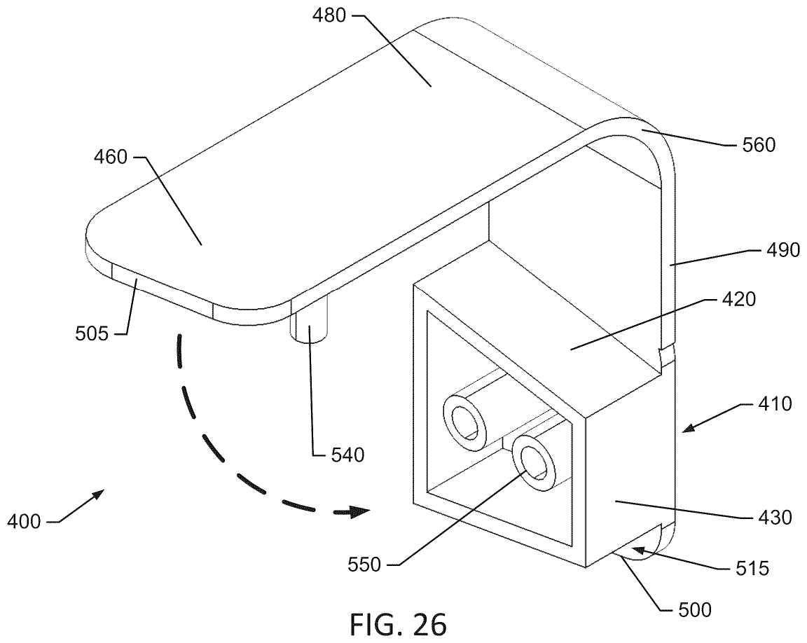

As shown in FIGS. 25 and 26, in some cases the first flange 480 and the second flange 490 may be integrally formed with one another and operably coupled by a bend portion 560. In this regard, the bend portion 560 may extend around the first jaw 104 and back to the stopper 410 to ensure the stopper 410 does not become removed from the cutting tool 100. In the embodiment of FIGS. 25 and 26, the third and fourth flanges (500, 505) may be substantially the same as the embodiment shown in FIG. 24. Thus, the third and fourth flanges (500, 505) may define a second channel 515 in which the second jaw 106 may be disposed when the stopper 410 may be operably coupled to the cutter blade assembly 102. In the embodiment shown in FIGS. 25 and 26, the operation prevention device 400 may be installed on the cutting tool 100 by first fitting the stopper 410 in between the first and second jaws (104, 106) while the stopper 410 is in an open state. Then, with the body of the stopper 410 being disposed between the first and second jaws (104, 106) and the bend portion 560 of the operation prevention device 400 extending around the first jaw 104, the fifth face 460 may be pivoted towards the body, about the bend portion 560, until the fifth face 460 may be operably coupled to the stopper 410 by fitting the attachment post 540 into the attachment receiver 550, which may be held in place via a snap fit.

Some example embodiments may provide for an operation prevention device for a cutting tool. The operation prevention device may include an outer shell having a first half shell member and a second half shell member which may be configured to be arranged in an open state and a closed state, a cavity which may be formed between the first half shell member and the second half shell member when the outer shell may be in the closed state, the cavity may be shaped to receive a cutter blade assembly of the cutting tool therein, and first and second locking portions which may secure the first half shell member to the second half shell member when the outer shell may be in the closed state. The cavity may be shaped to allow the cutter blade assembly of the cutting tool to move between fully opened and fully closed positions inside the outer shell.

The operation prevention device of some embodiments may include additional features, modifications, augmentations and/or the like to achieve further objectives or enhance performance of the operation prevention device. The additional features, modifications, augmentations and/or the like may be added in any combination with each other. Below is a list of various additional features, modifications, and augmentations that can each be added individually or in any combination with each other. For example, the cavity may include an opening formed between the first half shell member and the second half shell member. In some cases, the operation prevention device may further include a hinge operably coupling the first half shell member to the second half shell member, the first half shell member and the second half shell member being rotatable relative to each other about the hinge to transition the outer shell from the open state to the closed state. In an example embodiment, the cavity may further include an arcuate profile proximate to the hinge, a first recessed portion formed in the first half shell member and a second recessed portion formed in the second half shell member. In some cases, first and second jaws of the cutter blade assembly may extend through the opening into the cavity. In an example embodiment, the first and second jaws may include first and second cutting blades, respectively, that may be disposed within the arcuate profile of the cavity. In some cases, the first and second cutting blades may be movable within the arcuate profile of the cavity responsive to movement of first and second handles of the cutting tool, without removing the operation prevention device from the cutting tool. In an example embodiment, the first and second recessed portions in the cavity may be shaped to receive corresponding structures of the cutter blade assembly therein. In some cases, the cutter blade assembly may not be removable from the cavity through the opening due to the corresponding structures of the cutter blade assembly being disposed in respective ones of the first and second recessed portions. In an example embodiment, the outer shell may include one continuous piece of material that may be formed into the first half shell member, the hinge and the second half shell member. In some cases, the hinge may include a malleable portion of material integrally formed from the first and second half shell members. In an example embodiment, in the open state, the first half shell member and the second half shell member may be integrally operably coupled together only by the hinge. In some cases, the first locking portion may include a first flap that may be disposed at the first half shell member, and a second flap that may be disposed at the second half shell member. In an example embodiment, the second locking portion may include a third flap which may be disposed at the first half shell member, and a fourth flap which may be disposed at the second half shell member. In some cases, in the closed state, the first and second flaps may operably couple together and the third and fourth flaps may operably couple together. In an example embodiment, the first and second half shell members may be formed separately from each other as independent components of the operation prevention device. In some cases, the second half shell member may be substantially planar.

Some example embodiments may provide for an operation prevention device for a cutting tool. The operation prevention device may include a stopper removably operably coupleable to a cutter blade assembly of the cutting tool. The stopper may include a body having a first face, a second face, a third face, a fourth face, a fifth face and a sixth face. When the stopper may be operably coupled to the cutter blade assembly, the first and third faces may engage first and second jaws, respectively, of the cutter blade assembly to inhibit movement of the first and second jaws. The stopper may further include a first flange, a second flange, and a third flange to operably couple the stopper to the cutter blade assembly.

The operation prevention device of some embodiments may include additional features, modifications, augmentations and/or the like to achieve further objectives or enhance performance of the operation prevention device. The additional features, modifications, augmentations and/or the like may be added in any combination with each other. Below is a list of various additional features, modifications, and augmentations that can each be added individually or in any combination with each other. For example, the first and third faces may be angled relative to each other to define an acute angle therebetween. In an example embodiment, the second and fourth faces may be planar and disposed in first and second planes, respectively, the first and second planes may be substantially parallel to each other. In some cases, the fifth and sixth faces may be planar and disposed in third and fourth planes, respectively, the third and fourth planes may be substantially parallel to each other and substantially perpendicular to the first and second planes. In an example embodiment, the first flange may lie in the third plane and the second and third flanges may lie in the fourth plane. In some cases, the first face may be disposed between the first and second flanges, which may extend parallel to each other and away from the first face. In an example embodiment, the first face, the first flange and the second flange may define a first channel in which the first jaw may be disposed when the stopper may be operably coupled to the cutter blade assembly. In some cases, the stopper may further include a bore that may extend perpendicularly to, and entirely through, the fifth face and the sixth face of the body. In an example embodiment, when the stopper may be operably coupled to the cutter blade assembly, the third flange may be disposed on a first side of the second jaw. In some cases, a locking member may be inserted through the bore and around the second jaw to operably couple the stopper to the cutter blade assembly. In an example embodiment, the fifth face may be movable relative to the body and operably coupled to the body via a snap fit. In some cases, the stopper may further include a fourth flange that may lie in the third plane. In an example embodiment, the third face, the third flange and the fourth flange may define a second channel in which the second jaw may be disposed when the stopper may be operably coupled to the cutter blade assembly. In some cases, the fifth face may be formed separately from the body of the stopper. In an example embodiment, the fifth face may be formed integrally with the body of the stopper.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. An operation prevention device for a cutting tool, the operation prevention device comprising:
an outer shell having a first half shell member and a second half shell member configured to be arranged in an open state and a closed state;
a cavity formed between the first half shell member and the second half shell member when the outer shell is in the closed state, the cavity being shaped to receive a cutter blade assembly of the cutting tool therein; and
first and second locking portions to secure the first half shell member to the second half shell member when the outer shell is in the closed state,
wherein the cavity is shaped to allow the cutter blade assembly of the cutting tool to move between fully opened and fully closed positions inside the outer shell.

2. The operation prevention device of claim 1, wherein the cavity comprises an opening formed between the first half shell member and the second half shell member.

3. The operation prevention device of claim 1, wherein the operation prevention device further comprises a hinge operably coupling the first half shell member to the second half shell member, the first half shell member and the second half shell member being rotatable relative to each other about the hinge to transition the outer shell from the open state to the closed state.

4. The operation prevention device of claim 3, wherein the cavity further comprises an arcuate profile proximate to the hinge, a first recessed portion formed in the first half shell member and a second recessed portion formed in the second half shell member.

5. The operation prevention device of claim 4, wherein first and second jaws of the cutter blade assembly extend through the opening into the cavity, and
wherein the first and second jaws comprise first and second cutting blades, respectively, that are disposed within the arcuate profile of the cavity.

6. The operation prevention device of claim 5, wherein the first and second cutting blades are movable within the arcuate profile of the cavity responsive to movement of first and second handles of the cutting tool, without removing the operation prevention device from the cutting tool.

7. The operation prevention device of claim 4, wherein the first and second recessed portions in the cavity are shaped to receive corresponding structures of the cutter blade assembly therein, and
wherein the cutter blade assembly is not removable from the cavity through the opening due to the corresponding structures of the cutter blade assembly being disposed in respective ones of the first and second recessed portions.

8. The operation prevention device of claim 3, wherein the outer shell comprises one continuous piece of material that is formed into the first half shell member, the hinge and the second half shell member.

9. The operation prevention device of claim 8, wherein the hinge comprises a malleable portion of material integrally formed from the first and second half shell members, and
wherein in the open state, the first half shell member and the second half shell member are integrally operably coupled together only by the hinge.

10. The operation prevention device of claim 1, wherein the first locking portion comprises a first flap disposed at the first half shell member, and a second flap disposed at the second half shell member, and
wherein the second locking portion comprises a third flap disposed at the first half shell member, and a fourth flap disposed at the second half shell member.

11. The operation prevention device of claim 9, wherein in the closed state, the first and second flaps operably couple together and the third and fourth flaps operably couple together.

12. The operation prevention device of claim 1, wherein the first and second half shell members are formed separately from each other as independent components of the operation prevention device, or wherein the second half shell member is substantially planar.

13. An operation prevention device for a cutting tool, the operation prevention device comprising:
a stopper removably operably coupleable to a cutter blade assembly of the cutting tool,
wherein the stopper comprises a body having a first face, a second face, a third face, a fourth face, a fifth face and a sixth face,
wherein when the stopper is operably coupled to the cutter blade assembly, the first and third faces engage first and second jaws, respectively, of the cutter blade assembly to inhibit movement of the first and second jaws,
wherein the stopper further comprises a first flange, a second flange, and a third flange to operably couple the stopper to the cutter blade assembly.

14. The operation prevention device of claim 13, wherein the first and third faces are angled relative to each other to define an acute angle therebetween,
wherein the second and fourth faces are planar and disposed in first and second planes, respectively, the first and second planes being substantially parallel to each other, and
wherein the fifth and sixth faces are planar and disposed in third and fourth planes, respectively, the third and fourth planes being substantially parallel to each other and substantially perpendicular to the first and second planes.

15. The operation prevention device of claim 14, wherein the first flange lies in the third plane and the second and third flanges lie in the fourth plane.

16. The operation prevention device of claim 13, wherein the first face is disposed between the first and second flanges, which extend parallel to each other and away from the first face.

17. The operation prevention device of claim 16, wherein the first face, the first flange and the second flange define a first channel in which the first jaw is disposed when the stopper is operably coupled to the cutter blade assembly.

18. The operation prevention device of claim 13, wherein the stopper further comprises a bore extending perpendicularly to, and entirely through, the fifth face and the sixth face of the body.

19. The operation prevention device of claim 18, wherein when the stopper is operably coupled to the cutter blade assembly, the third flange is disposed on a first side of the second jaw, and
wherein a locking member is inserted through the bore and around the second jaw to operably couple the stopper to the cutter blade assembly.

20. The operation prevention device of claim 14, wherein the fifth face is movable relative to the body and operably coupled to the body via a snap fit, or wherein the stopper further comprises a fourth flange that lies in the third plane, or wherein the third face, the third flange and the fourth flange define a second channel in which the second jaw is disposed when the stopper is operably coupled to the cutter blade assembly, and wherein the fifth face is formed separately from the body of the stopper, or formed integrally with the body of the stopper.
